(19) United States
(12) Patent Application Publication
(10) Pub. No.: US 2011/0155302 A1
(43) Pub. Date: Jun. 30, 2011

(54) METHOD OF MAKING A COMPOSITE PANEL ASSEMBLY

(75) Inventors: Hsien-Te CHENG, Tainan Hsien (TW); Hsien-Sung CHENG, Tainan Hsien (TW)

(73) Assignee: XXENTRIA TECHNOLOGY MATERIALS CO., LTD., Tainan Hsien (TW)

(21) Appl. No.: 12/882,765

(22) Filed: Sep. 15, 2010

(30) Foreign Application Priority Data
Dec. 30, 2009 (TW) 098145903

(51) Int. Cl. B32B 37/16; B32B 37/12

(52) U.S. Cl. 156/182

(57) ABSTRACT

A method of making a composite panel assembly includes: (a) preparing two composite panels each of which has first and second face layers sandwiching a core, the first face layer having a main covering section and an extension; (b) mating the two composite panels; (c) placing a heat-sensitive adhesive sheet over the extension of the first face layer of each of the composite panels before the mating of the two composite panels; (d) heating parts of the composite panels that are mated; and (e) cooling the parts of the composite panels.

### CROSS-REFERENCE TO RELATED APPLICATION

This application claims priority of Taiwanese application No. 098145903, filed on Dec. 30, 2009.

### BACKGROUND OF THE INVENTION

1. Field of the Invention

This invention relates to a method of making a composite panel assembly, more particularly to a method of making a composite panel assembly including using a heat-sensitive adhesive sheet.

2. Description of the Related Art

Referring to FIG. 1, a conventional composite panel assembly 1 includes two composite panels 11. Each of the composite panels 11 includes a core 12, and first and second face layers 13, 14 sandwiching the core 12 therebetween. The core 12 of each of the composite panels 11 has a mating end section 121 proximate to the other composite panel 11. The first face layer 13 of each of the composite panels 11 has an extension 131 extending beyond the mating end section 121 of the core 12. The second face layer 14 of each of the composite panels 11 has an attaching section 141 covering the mating end section 121 of the core 12. The two composite panels 11 are assembled together through applying two adhesive layers 16 between the extension 131 of one of the composite panels 11 and the attaching section 141 of the other of the composite panels 11, and between the attaching section 141 of the one of the composite panels 11 and the extension 131 of the other of the composite panels 11, respectively. Each of the composite panels 11 further includes a baked coating 15 formed on outer surfaces of the first and second face layers 13, 14.

FIGS. 2a to 2d illustrate a method of making the above-described composite panel assembly 1. The method includes: attaching the first and second face layers 13, 14 to the respective cores 12 to form the two composite panels 11 (see FIG. 2a); baking a coating applied to an outer surface of each of the first and second face layers 13, 14 of the two composite panels 11 so as to form the baked coating 15 thereon (see FIG. 2b); and applying an adhesive layer 16 to an inner surface opposite to the outer surface of the extension 131 of the first face layer 13 of each of the composite panels 11 (see FIG. 2c). Subsequently, the two composite panels 11 are mated so that the extension 131 of the first face layer 13 of each of the composite panels 11 extends over the attaching section 141 of the second face layer 14 of the other composite panel (see FIG. 2d). After the adhesive layers 16 are dried, the two composite panels 11 are bonded together. However, since the adhesive used as the adhesive layers 16 is a two-component adhesive, drying of the adhesive layers 16 requires a relatively long time and thus, much space is taken up by the composite panels 11 with incompletely dried adhesive layers 16. In addition, since the adhesive used as the adhesive layers 16 is made from an epoxy resin material that usually contains volatile organic compounds (VOC) or other toxic components, safety concerns as well as health and environmental concerns, arise.

### SUMMARY OF THE INVENTION

Therefore, an object of the present invention is to provide a method of making a composite panel assembly that can overcome the aforesaid drawbacks associated with the prior art.

According to the present invention, a method of making a composite panel assembly comprises: (a) preparing at least two composite panels each of which has first and second face layers sandwiching a core, the core having a main core section and a mating end section, the first face layer having a main covering section covering the main core and mating end sections, and an extension extending beyond the mating end section, the second face layer covering the main core and mating end sections; (b) mating the two composite panels so that the extension of the first face layer of each of the composite panels extends over the second face layer of the other composite panel; (c) placing a heat-sensitive adhesive sheet over the extension of the first face layer of each of the composite panels before the mating of the two composite panels so that the heat-sensitive adhesive sheet lies between the extension of the first face layer of the respective composite panel and the second face layer of the other composite panel after the mating of the two composite panels; (d) heating parts of the composite panels that are mated so that the heat-sensitive adhesive sheet is fused; and (e) cooling the parts of the composite panels so that the extension of the first face layer of each of the composite panels is bonded to the second face layer of the other composite panel by the respective heat-sensitive adhesive sheet.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary assembled sectional view of a conventional composite panel assembly;

FIGS. 2a to 2d are views to illustrate consecutive steps of a method of making the conventional composite panel assembly;

FIG. 3 is a fragmentary exploded sectional view of a composite panel assembly made through the first preferred embodiment of a method according to this invention;

FIG. 4 is a fragmentary assembled sectional view of the composite panel assembly made through the first preferred embodiment of the method according to this invention;

FIG. 5 is a flowchart to illustrate consecutive steps of the first preferred embodiment of the method of making the composite panel assembly;

FIGS. 6a to 6f are views to illustrate consecutive steps of the first preferred embodiment of the method of making the composite panel assembly;

FIG. 7 is a schematic view showing how two composite panels mated with each other may be advanced to pass through a heating device and a cooling device;

FIGS. 8 and 9 are schematic views illustrating heating and cooling devices moving toward and away from the two composite panels mated with each other;

FIG. 10 is a fragmentary assembled sectional view of the composite panel assembly made through the second preferred embodiment of a method according to this invention; and

FIGS. 11a to 11e are views to illustrate consecutive steps of the second preferred embodiment of the method of making the composite panel assembly.

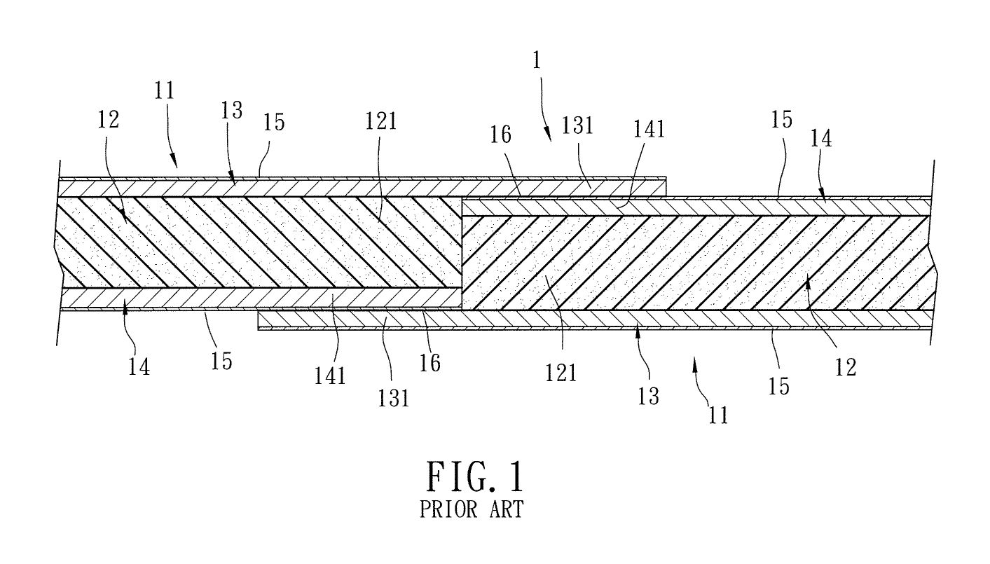

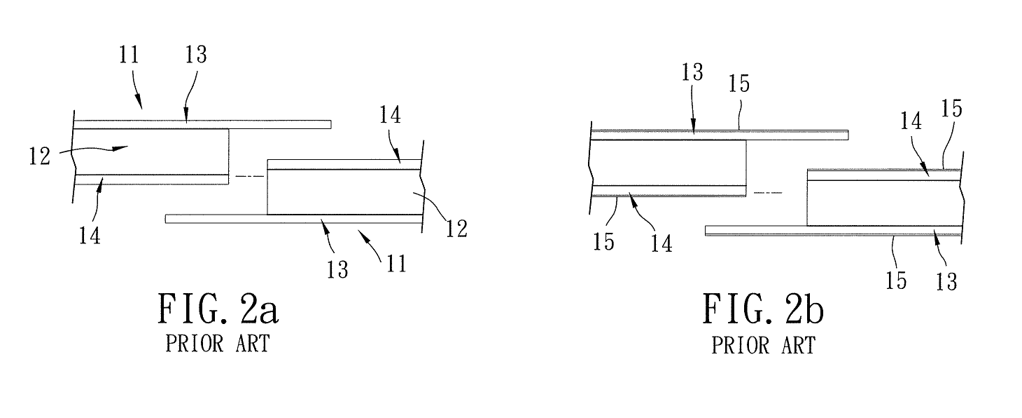

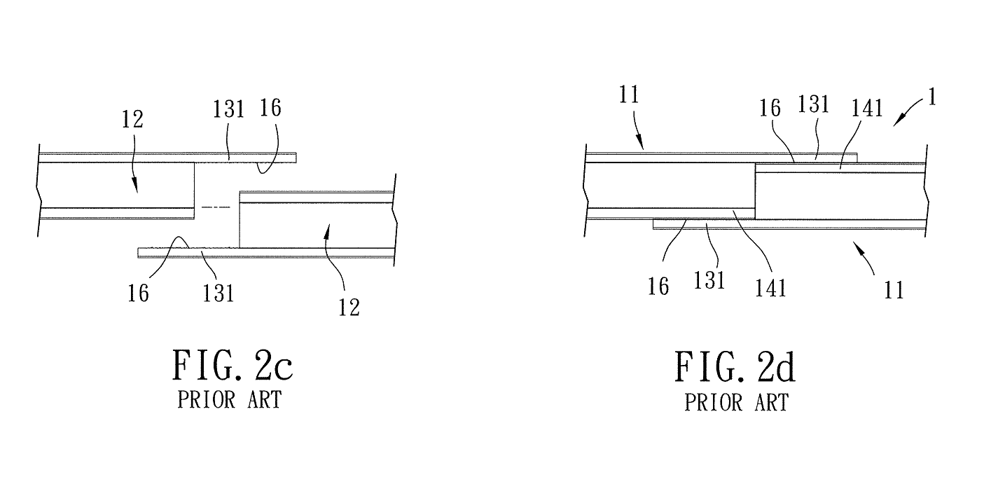

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

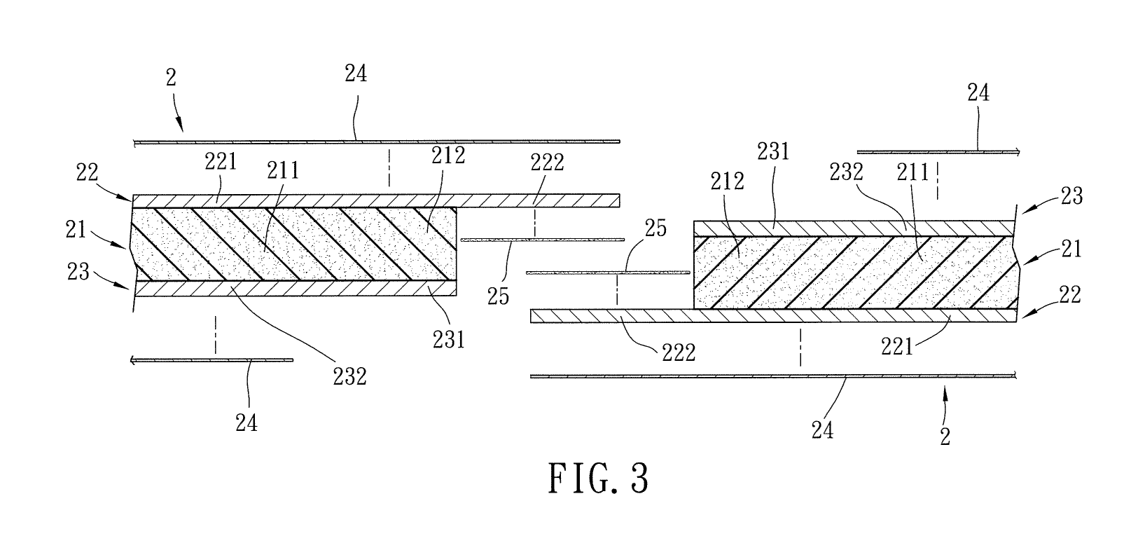

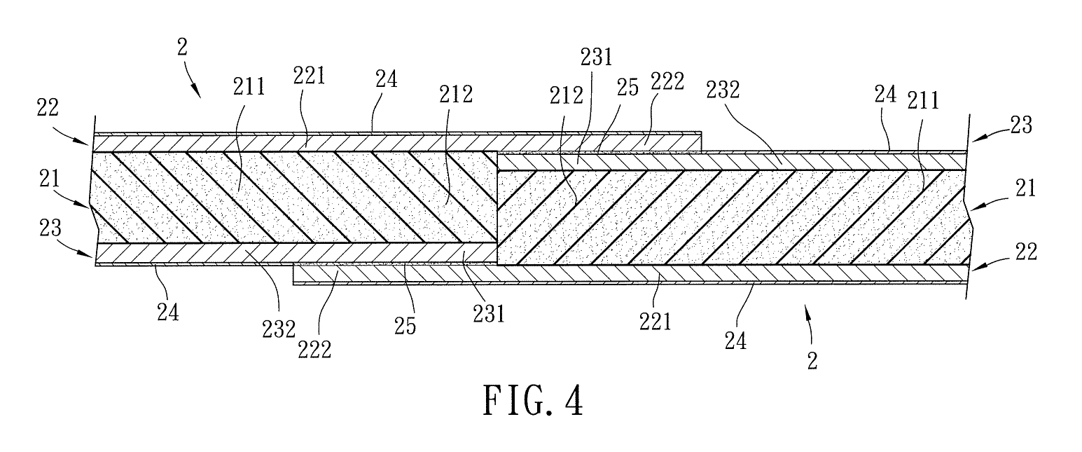

Referring to FIGS. 3 and 4, a composite panel assembly is made through a method according to the first preferred embodiment of this invention.

The composite panel assembly includes two composite panels 2. Each of the composite panels 2 has first and second face layers 22, 23 sandwiching a core 21. The core 21 may be made from a plastic material or a foam of the plastic material made by incorporating a conventional foaming agent thereinto. Preferably, the plastic material is selected from the group consisting of polyethylene (PE), polypropylene (PP), ethylene-vinyl acetate copolymer (EVA), and combinations thereof. Each of the first and second face layers 22, 23 may be made of a metal sheet selected from the group consisting of an aluminum alloy sheet, a zinc-plated steel sheet, an aluminum zinc-plated steel sheet, an aluminum zinc magnesium-plated steel sheet, a titanium alloy sheet, a copper alloy sheet, a stainless steel sheet, a zinc alloy sheet, a paint coated steel sheet, and combinations thereof.

The core 21 has a main core section 211 and a mating end section 212. The first face layer 22 has a main covering section 221 covering the main core and mating end sections 211,212, and an extension 222 extending beyond the mating end section 212. The second face layer 23 covers the main core and mating end sections 211,212 and has an attaching section 231 covering the mating end section 212, and a main covering section 232 covering the main core section 211. Preferably, the attaching section 231 has a length corresponding to that of the extension 222.

The extension 222 of the first face layer 22 of each of the composite panels 2 extends over the attaching section 231 of the second face layer 23 of the other composite panel 2.

Each of the composite panels 2 further has a baked coating 24 formed on outer surfaces of the first and second face layers 22, 23 excluding the attaching section 231 of the second face layer 23, and a heat-sensitive adhesive sheet 25 attached to an inner surface of the extension 222 of the first face layer 22 that is to be disposed to overlap the attaching section 231 of the second face layer 23 of the other composite panel 2.

Preferably, the heat-sensitive adhesive sheet 25 is made from a polymer material selected from the group consisting of maleic anhydride grafted polyethylene, maleic anhydride grafted polypropylene, maleic anhydride grafted ethylene-vinyl acetate copolymer, and combinations thereof. Since the polymer material contains no volatile organic component (VOC) or other toxic components, it is safe to use and is environmentally friendly when used.

Preferably, the baked coating 24 is made from a resin material selected from the group consisting of polyester resin, silicone-modified polyester resin, acrylic resin, polyvinylidene fluoride resin, fluoroethylene vinyl ether resin, and combinations thereof.

It is noted that depending upon whether the composite panel assembly is further mated with other composite panels 2 or not, the extension 222 and the mating end section 212 may be formed on one or both ends of the composite panels 2.

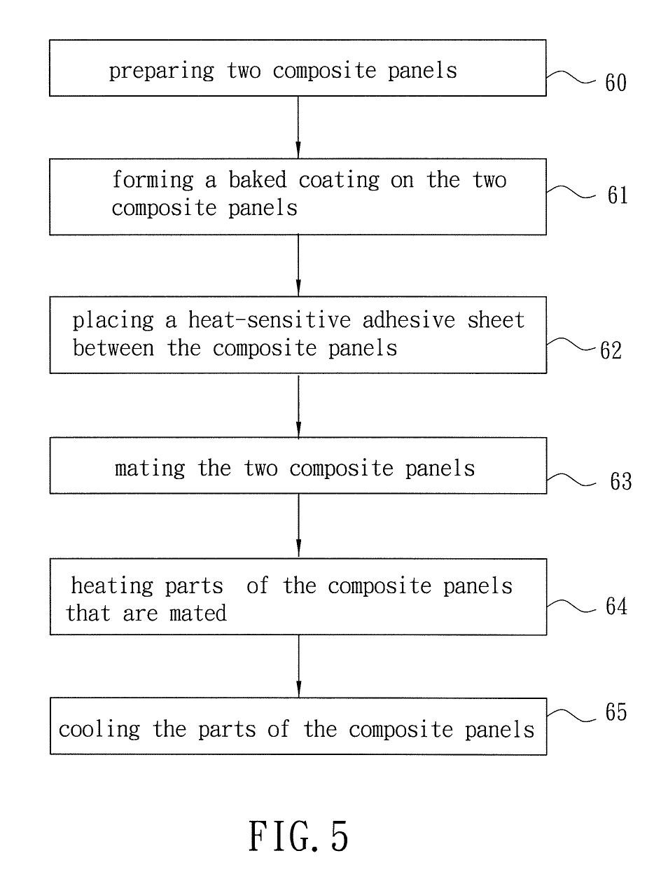

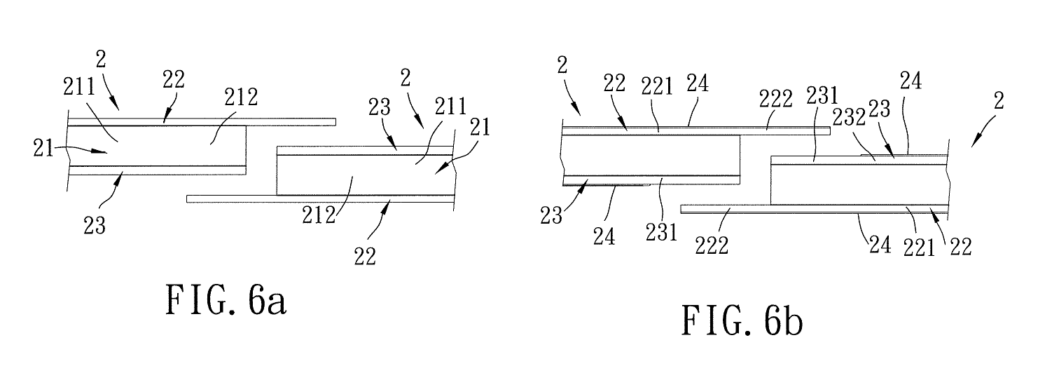

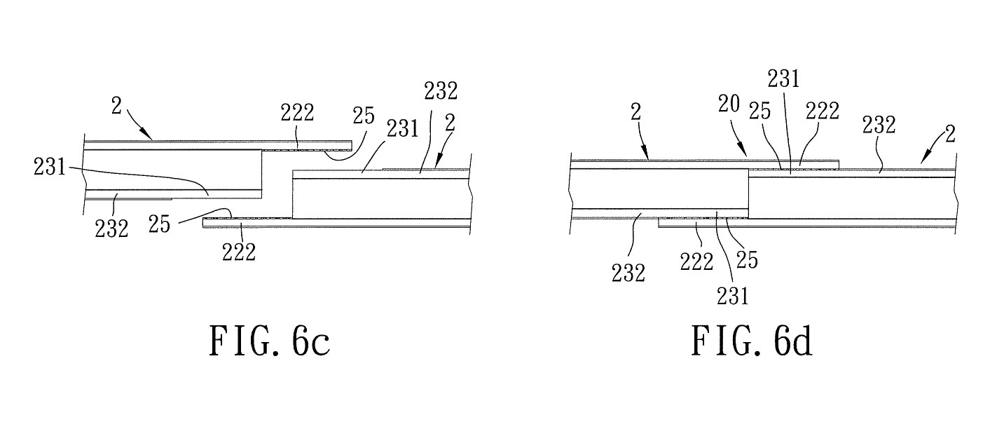

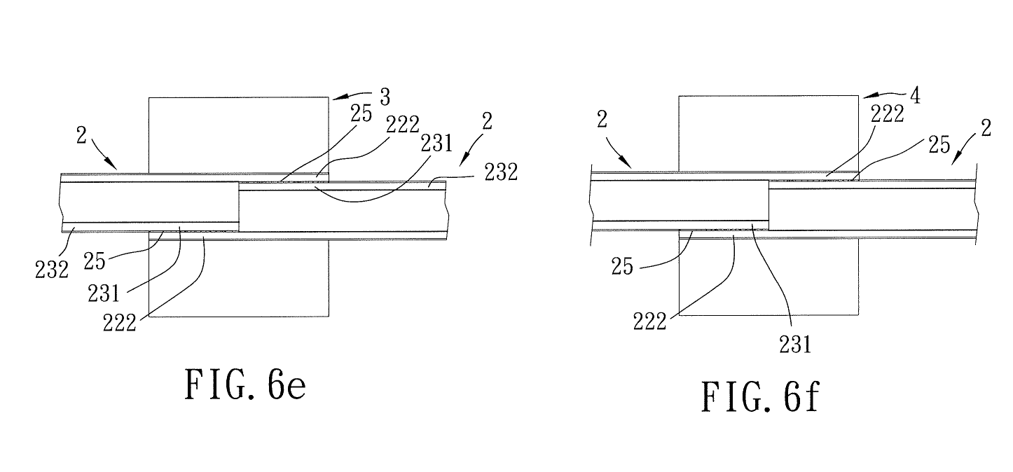

Referring to FIGS. 5 and 6a to 6f, the first preferred embodiment of the method of making the composite panel assembly according to this invention includes steps 60 to 65.

In step 60, as shown in FIG. 6a, two composite panels 2 are provided. The two composite panels 2 are made by the same process in which an adhesive is uniformly applied to two opposite sides of each of the cores 21 of the composite panels 2, and then each of the cores 21 is advanced to be disposed between the first and second face layers 22, 23 and is pressed together and adhered with the first and second face layers 22, 23 by the adhesive.

In step 61, as shown in FIG. 6b, a coating is applied to the outer surface of the main covering section 221 and the extension 222 of the first face layer 22, and the outer surface of the second face layer 23 excluding the attaching section 231 of the second face layer 23, and then is baked so as to form the baked coating 24.

In step 62, as shown in FIG. 6c, two heat-sensitive adhesive sheets 25 are placed over the inner surface of the extension 222 of the first face layer 22 of each of the composite panels 2. Alternatively, the heat-sensitive adhesive sheets 25 may be placed over the attaching section 231 of the second face layer 23 of each of the composite panels 2.

In step 63, as shown in FIG. 6d, the two composite panels 2 are mated so that the extension 222 of the first face layer 22 of each of the composite panels 2 extends over the attaching section 231 of the second face layer 23 of the other composite panel 2, and so that the two heat-sensitive adhesive sheet 25 are interposed between the extension 222 of the first face layer 22 of each of the composite panels 2 and the attaching section 231 of the second face layer 23 of the other composite panel 2.

In step 64, as shown in FIG. 6e, parts of the composite panels 2 that are mated, preferably, the mated portions including the extensions 222 of the first face layers 22 and the corresponding attaching sections 231 of the second face layers 23 and the heat-sensitive adhesive sheets 25 interposed therebetween, are passed through a heating device 3 so that the heat-sensitive adhesive sheets 25 are fused.

In step 65, as shown in FIG. 6f, the parts of the mated composite panels 2 with the fused heat-sensitive adhesive sheets 25, preferably the mated portions, are passed through a cooling device 4 so that the extension 222 of the first face layer 22 of each of the composite panels 2 is bonded to the attaching section 231 of the second face layer 23 of the other composite panel 2 by the respective heat-sensitive adhesive sheet 25.

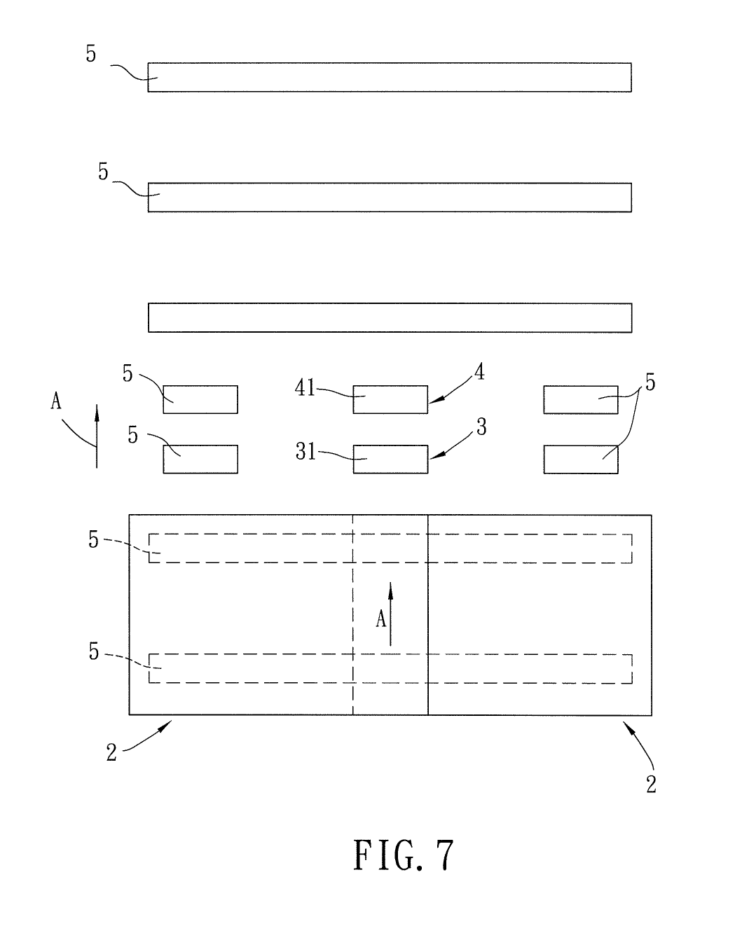

In this embodiment, each heat-sensitive adhesive sheet 25 has a melting point ranging from 90° C. to 135° C. Further referring to FIG. 7, in one preferred embodiment, the heating device 3 includes at least one hollow hot press roller 31. The hollow hot press roller contains a heating medium having a temperature ranging from 150° C. to 200° C., such as heated oil, therein. The cooling device 4 includes at least one hollow cold press roller 41. The hollow cold press roller 41 contains a cooling medium having a temperature ranging from 10° C. to 80° C. therein. In another preferred embodiment, a conveyer including several rollers 5 (see FIG. 7) is used to advance the composite panels 2 that are mated toward a direction, as indicated by arrows (A), to pass through the heating device 3 and subsequently the cooling device 4 for performing steps 64 and 65.

Alternatively, the composite panels 2 that are mated may be heated using the heating device 3 by way of laser, ultrasonic wave, high frequency microwave, hot air, magnetic wave, or radiation. In addition, the composite panels 2 may be cooled using the cooling device 4 that employs liquid nitrogen or liquid carbon dioxide.

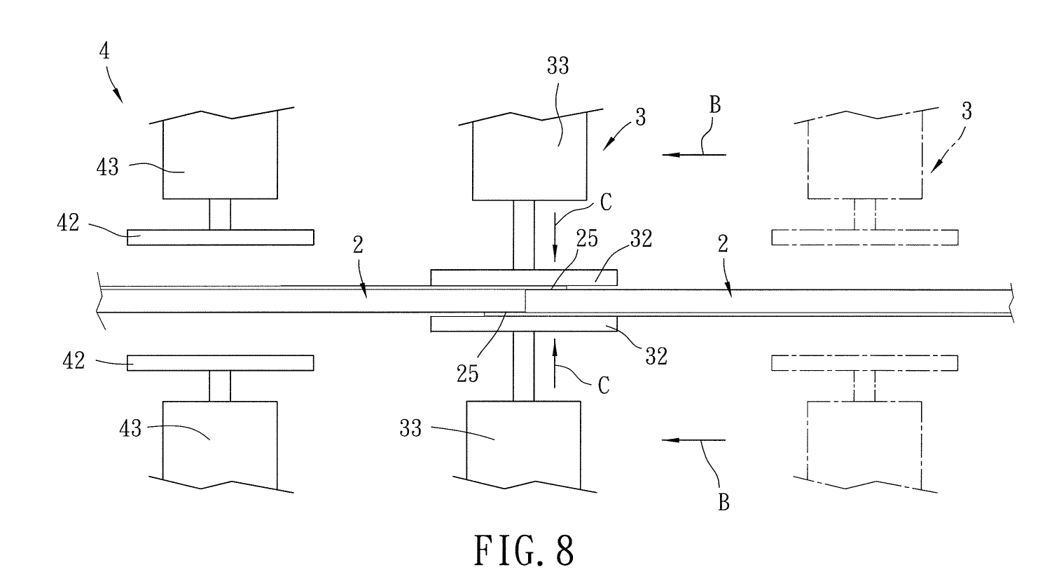

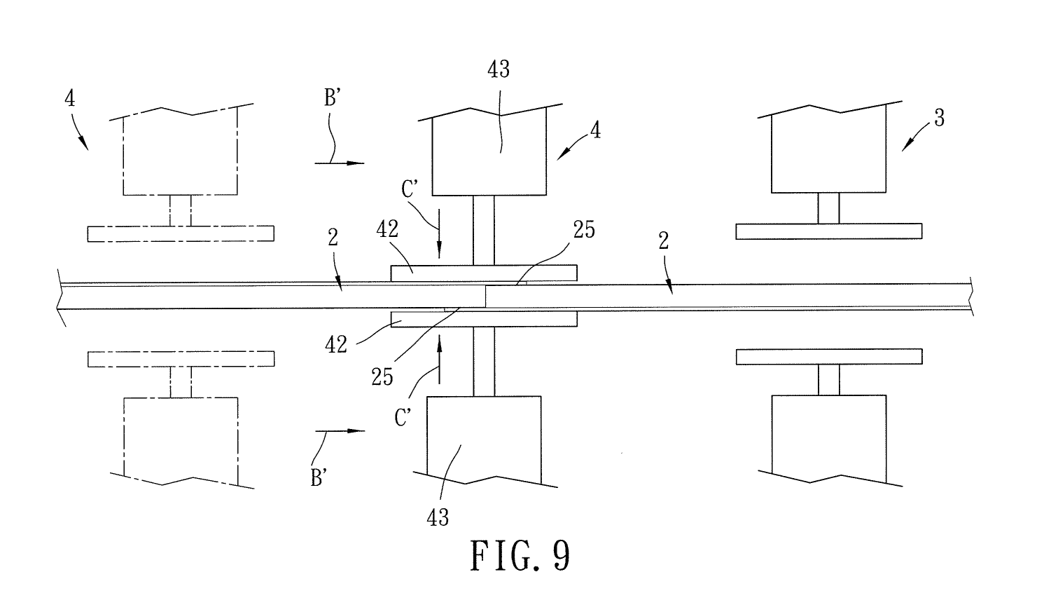

Referring to FIGS. 8 and 9, in an alternative embodiment, the heating device 3 used in the first preferred embodiment to perform step 64 may include two heating plates 32 disposed at two opposite sides of the composite panel assembly of the composite panels 2 that are mated, and two plungers 33 respectively connected to the heating plates 32 and operable to move the respective heating plates 32 toward and away from the composite panels 2. In another alternative embodiment, the cooling device 4 for performing step 65 may include two cooling plates 42 disposed at two opposite sides of the composite panel assembly of the composite panels 2 that are mated, and two plungers 43 respectively connected to the cooling plates 42 and operable to move the respective cooling plates 42 toward and away from the composite panels 2.

In use, referring back to FIG. 8, the heating device 3 is moved to the composite panels 2 that are mated, as indicated by arrows (B), and the plungers 33 are operated to move the heating plates 32 toward two opposite sides of the composite panel assembly of the composite panels 2, as indicated by arrows (C) for hot pressing the composite panels 2. After hot pressing, the heating device 3 is moved away from the composite panels 2 and back to its original position. Referring back to FIG. 9, the cooling device 4 is moved to the composite panels 2 that are mated, as indicated by arrows (B′), and the plungers 43 are operated to move the cooling plates 42 toward two opposite sides of the composite panel assembly of the composite panels 2, as indicated by arrows (C′), for cooling the composite panels 2. After cooling, the cooling device 4 is moved away from the composite panels 2 and back to its original position. Alternatively, the movement of the heating device 3 and the cooling device 4 in the directions B and B′ may be replaced by the movement of the mated composite panels 2 that are advanced to sequentially pass through the heating device 3 and the cooling device 4.

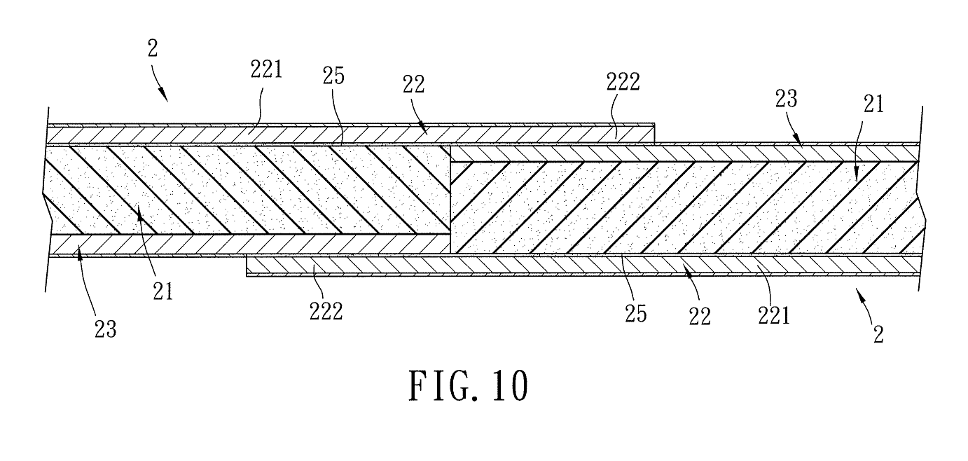

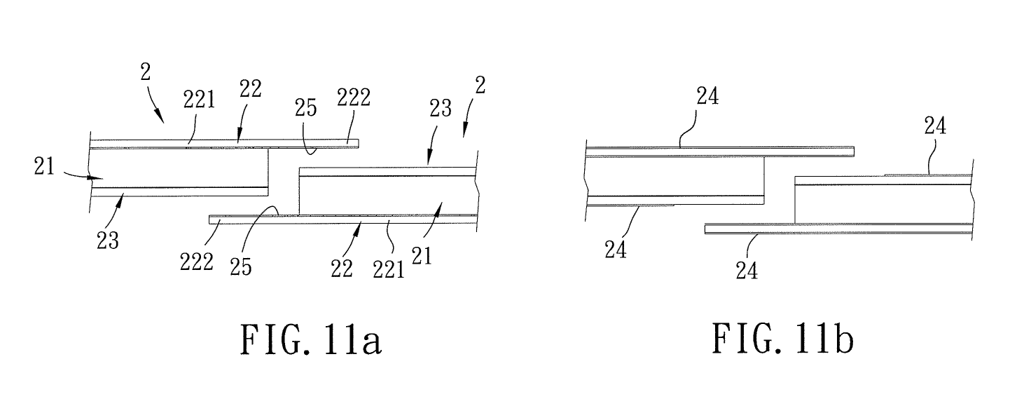

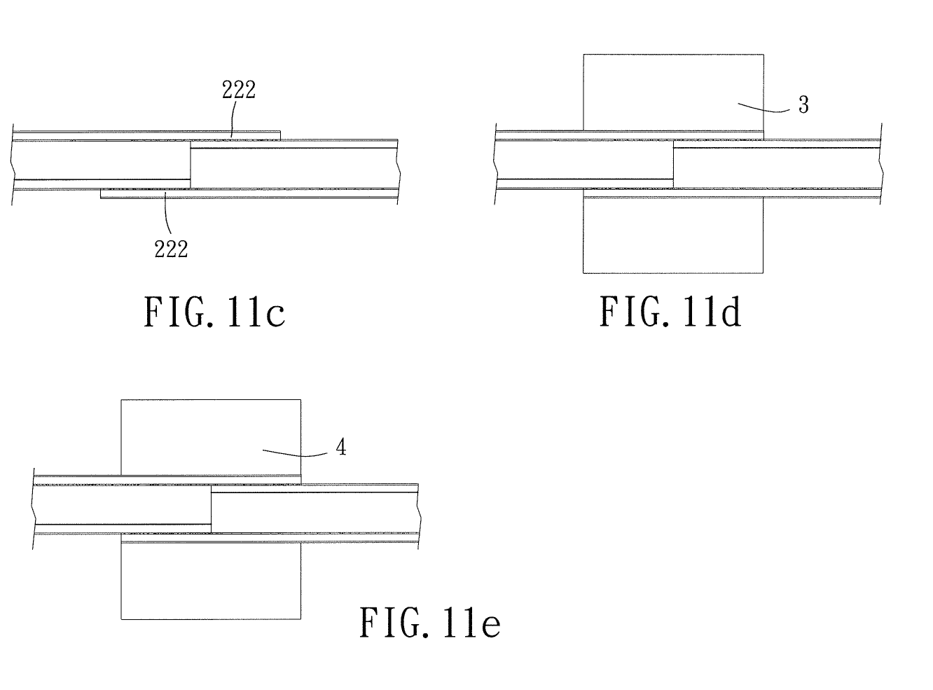

Referring to FIGS. 10 and 11a to 11e, the second preferred embodiment of the method according to this invention is shown to be similar to the first preferred embodiment. However, in this embodiment, in step 60, a heat-sensitive adhesive sheet 25 is placed over the surface of the first face layer 22 that will constitute the inner surfaces of the main covering section 221 and the extension 222 of the first face layer 22. Thus, the first face layer 22 of each of the composite panels 2 is bonded to the core 21 by using the heat-sensitive adhesive sheet 25 over the main covering section 221. Subsequently, step 61 is performed to form the baked coating 24, step 62 is omitted, and steps 63 to 65 are performed to bond the composite panels 2 together.

In the embodiments according to this invention, the baked coating 24 is not formed on the attaching sections 231 of the second face layers 23 of the composite panels 2, and each heat-sensitive adhesive sheet 25 is directly placed over the attaching section 231 or the inner surface of the extension 222 before the two composite panels 2 are mated. After mating of the two composite panels 2, the composite panels 2 that are mated are heated and cooled so as to speed up formation of the composite panel assembly through the heat-sensitive adhesive sheets 25. Besides, since the heat-sensitive adhesive sheets 25 are in direct contact with the attaching sections 231 and the corresponding inner surfaces of the extensions 222, it is unnecessary to give any attention to the adhesion effect of the heat-sensitive adhesive sheets 25 to the baked coating 24. In addition, the heat-sensitive adhesive sheet 25 can be used as a protective film, thereby alleviating oxidation and corrosion of the composite panels 2.

Alternatively, if it is desired to form a baked coating 24 on the attaching sections 231 of the second face layers 23, the baked coating 24 may be modified to be made from a material that does not adversely affect the subsequent bonding of the composite panels 2, such as epoxy resin.

With the invention thus explained, it is apparent that various modifications and variations can be made without departing from the spirit of the present invention. It is therefore intended that the invention be limited only as recited in the appended claims.

What is claimed is:

1. A method of making a composite panel assembly, comprising:
(a) preparing at least two composite panels each of which has first and second face layers sandwiching a core, the core having a main core section and a mating end section, the first face layer having a main covering section covering the main core and mating end sections, and an extension extending beyond the mating end section, the second face layer covering the main core and mating end sections;
(b) mating the two composite panels so that the extension of the first face layer of each of the composite panels extends over the second face layer of the other composite panel;
(c) placing a heat-sensitive adhesive sheet over the extension of the first face layer of each of the composite panels before the mating of the two composite panels so that the heat-sensitive adhesive sheet lies between the extension of the first face layer of the respective composite panel and the second face layer of the other composite panel after the mating of the two composite panels;
(d) heating parts of the composite panels that are mated so that the heat-sensitive adhesive sheet is fused; and
(e) cooling the parts of the composite panels so that the extension of the first face layer of each of the composite panels is bonded to the second face layer of the other composite panel by the respective heat-sensitive adhesive sheet.

2. The method of claim 1, wherein the composite panels are advanced by a conveyer that passes through a heating device to perform step (d) and thereafter through a cooling device to perform step (e).

3. The method of claim 2, wherein the heating device includes at least one hollow hot press roller containing a heating medium therein, and the cooling device includes at least one hollow cold press roller containing a cooling medium therein.

4. The method of claim 1, wherein a heating device that is movable toward and away from the composite panels is used to perform step (d), and a cooling device that is movable toward and away from the composite panels is used to perform step (e).

5. The method of claim 4, wherein the heating device includes two heating plates disposed at two opposite sides of the composite panels that are mated, and two plungers respectively connected to the heating plates and operable to move the respective heating plates toward and away from the composite panels, and the cooling device includes two cooling plates disposed at two opposite sides of the composite panels that are mated, and two plungers respectively connected to the cooling plates and operable to move the respective cooling plates toward and away from the composite panels.

6. The method of claim 1, wherein the heating in step (d) is conducted under a temperature ranging from 150° C. to 200° C. and the cooling in step (e) is conducted under a temperature ranging from 10° C. to 80° C.

7. The method of claim 1, further comprising forming a baked coating on outer surfaces of the first and second face layers of the composite panels.

8. The method of claim 1, wherein, in step (a), each of the composite panels is prepared by bonding the first face layer to the core using a heat-sensitive adhesive sheet.

9. The method of claim 1, wherein the heat-sensitive adhesive sheet is made of a material selected from the group consisting of maleic anhydride grafted polyethylene, maleic anhydride grafted polypropylene, maleic anhydride grafted ethylene-vinyl acetate copolymer, and combinations thereof.
